(19) United States
(12) Patent Application Publication
(10) Pub. No.: US 2014/0033689 A1
(43) Pub. Date: Feb. 6, 2014

(54) METERLESS HYDRAULIC SYSTEM HAVING FORCE MODULATION

(71) Applicant: Patrick OPDENBOSCH, Peoria, IL (US)

(72) Inventor: Patrick OPDENBOSCH, Peoria, IL (US)

(21) Appl. No.: 13/563,248

(22) Filed: Jul. 31, 2012

(51) Int. Cl. F15B 13/00

(52) U.S. Cl. 60/325

(57) ABSTRACT

A hydraulic system is disclosed. The hydraulic system may have a pump configured to draw low-pressure fluid from one of a first passage and a second passage and discharge fluid into the other of the first and second passages, and an actuator coupled to the pump via the first and second passages. The hydraulic system may also have at least a first control valve fluidly connected between the first and second passages to selectively direct fluid from one of the first and second passages to bypass the pump and flow into the other of the first and second passages. The hydraulic system may further have at least a second control valve fluidly connected in parallel with the at least a first control valve to selectively direct fluid from one of the first and second passages to bypass the actuator and flow into the other of the first and second passages.

### TECHNICAL FIELD

The present disclosure relates generally to a hydraulic system and, more particularly, to a meterless hydraulic system having force modulation.

### BACKGROUND

A conventional hydraulic system includes a pump that draws low-pressure fluid from a tank, pressurizes the fluid, and makes the pressurized fluid available to multiple different actuators for use in moving the actuators. In this arrangement, a speed and/or force of each actuator can be independently controlled by selectively throttling (i.e., restricting) a flow of the pressurized fluid from the pump into and/or out of each actuator. For example, to move a particular actuator at a higher speed and/or with a higher force, the flow of fluid from the pump into the actuator is unrestricted or restricted by only a small amount. In contrast, to move the same or another actuator at a lower speed and/or with a lower force, the restriction placed on the flow of fluid is increased. Although adequate for many applications, the use of fluid restriction to control actuator speed or force can result in flow losses that reduce an overall efficiency of the hydraulic system.

An alternative type of hydraulic system is known as a meterless hydraulic system. A meterless hydraulic system generally includes a pump connected in closed-loop fashion to a single actuator or to a pair of actuators operating in tandem. During operation, the pump draws fluid from one chamber of the actuator(s) and discharges pressurized fluid to an opposing chamber of the same actuator(s). To move the actuator(s) at a higher speed, the pump discharges fluid at a faster rate. To move the actuator with a lower speed, the pump discharges the fluid at a slower rate. A meterless hydraulic system is generally more efficient than a conventional hydraulic system because the speed of the actuator(s) is controlled through pump operation as opposed to fluid restriction. That is, the pump is controlled to only discharge as much fluid as is necessary to move the actuator(s) at a desired speed, and little or no throttling of the fluid flow is required.

An exemplary meterless hydraulic system is disclosed in U.S. Patent Publication 2008/0250783 of Griswold that published on Oct. 16, 2008 (the '783 publication). In the '783 publication, a multi-actuator closed-loop hydraulic system is described. The hydraulic system includes a first circuit having a first actuator connected to a first pump in a closed-loop manner, and a second circuit having a second actuator connected to a second pump in a closed-loop manner. The hydraulic system also includes a third pump connected in an open-loop manner to the first and second circuits to provide additional flow to the first and second circuits.

The closed-loop hydraulic system of the '783 publication described above may be less than optimal. In particular, the system does not disclose a way to modulate a force of the actuators.

The hydraulic system of the present disclosure is directed toward solving one or more of the problems set forth above and/or other problems of the prior art.

### SUMMARY

In one aspect, the present disclosure is directed to a hydraulic system. The hydraulic system may include a pump configured to draw low-pressure fluid from one of a first passage and a second passage and discharge fluid into the other of the first and second passages, and an actuator coupled to the pump via the first and second passages. The hydraulic system may also have at least a first control valve fluidly connected between the first and second passages and configured to selectively direct fluid from one of the first and second passages to bypass the pump and flow into the other of the first and second passages. The hydraulic system may further have at least a second control valve fluidly connected in parallel with the at least a first control valve and configured to selectively direct fluid from one of the first and second passages to bypass the actuator and flow into the other of the first and second passages.

In another aspect, the present disclosure is directed to a method of operating a hydraulic system. The method may include drawing fluid from one of a first chamber and a second chamber of an actuator, pressurizing the fluid with a pump, and directing the pressurized fluid into the other of the first and second chambers of the actuator to move the actuator. The method may also include selectively directing a first flow of fluid from the actuator to bypass the pump and recuperate energy from the first flow of fluid. The method may further include selectively directing a second flow of fluid from the pump to bypass the actuator in parallel with the first flow of fluid to selectively reduce a force of the actuator.

### BRIEF DESCRIPTION OF THE DRAWINGS

FIG. 1 is a pictorial illustration of an exemplary disclosed machine; and

FIG. 2 is a schematic illustration of an exemplary disclosed hydraulic system that may be used in conjunction with the machine of FIG. 1.

### DETAILED DESCRIPTION

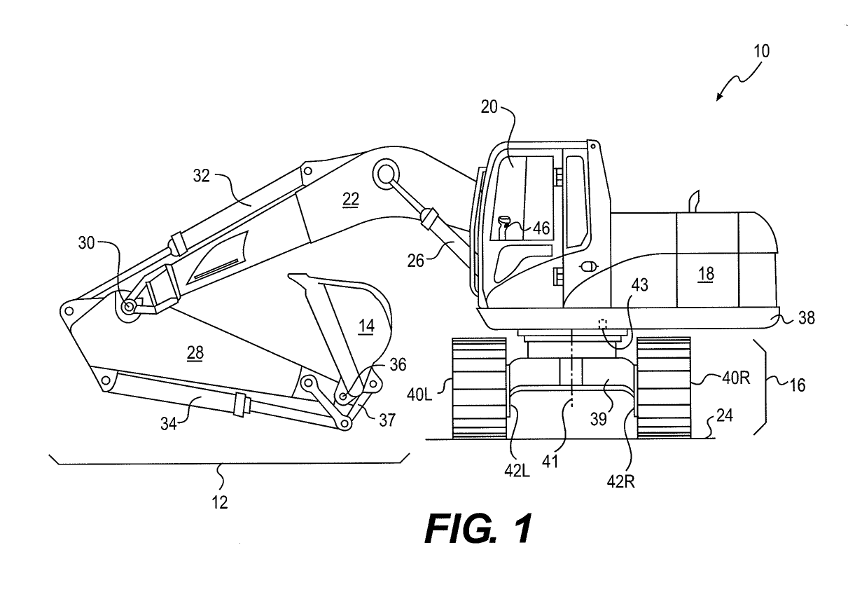

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as the excavator shown in FIG. 1, a dozer, a loader, a backhoe, a motor grader, a dump truck, or any other earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by fluid actuators to move work tool 14. In the disclosed exemplary embodiment, implement system 12 includes a boom 22 that is vertically pivotal about a horizontal axis (not shown) relative to a work surface 24 by a pair of adjacent, double-acting, hydraulic cylinders 26 (only one shown in FIG. 1). Implement system 12 also includes a stick 28 that is vertically pivotal about a horizontal axis 30 by a single, double-acting, hydraulic cylinder 32, and a single, double-acting, hydraulic cylinder 34 that is operatively connected between stick 28 and work tool 14 to pivot work tool 14 vertically about a horizontal pivot axis 36. In the disclosed embodiment, hydraulic cylinder 34 is connected to work tool 14 by way of a power link 37, although other connections may also be possible. Boom 22 may be pivotally connected to a body 38 of machine 10, and body 38 may be pivotally connected to an undercarriage 39 and movable about a vertical axis 41 by a hydraulic swing motor 43. Stick 28 may pivotally connect boom 22 to work tool 14 by way of axis 30 and 36. It is contemplated that implement system 12 may be arranged differently, if desired.

Numerous different work tools 14 may be attachable to a single machine 10 and operator controllable. Work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction, work tool 14 may alternatively or additionally rotate, slide, open and close, or move in any other manner known in the art.

Drive system 16 may include one or more traction devices powered to propel machine 10. In the disclosed example, drive system 16 includes a left track 40L located at one side of machine 10, and a right track 40R located at an opposing side of machine 10. Left track 40L may be driven by a left travel motor 42L, while right track 40R may be driven by a right travel motor 42R. It is contemplated that drive system 16 could alternatively include traction devices other than tracks, such as wheels, belts, or other known traction devices. Machine 10 may be steered by generating a speed and/or rotational direction difference between left and right travel motors 42L, 42R, while straight travel may be facilitated by generating substantially equal output speeds and rotational directions from left and right travel motors 42L, 42R.

Power source 18 may embody an engine such as, for example, a diesel engine, a gasoline engine, a gaseous fuel-powered engine, or any other type of combustion engine known in the art. It is contemplated that, in some applications, power source 18 may alternatively embody a non-combustion source of power such as a fuel cell, a power storage device, or another source known in the art. Power source 18 may produce a mechanical or electrical power output that may then be converted to hydraulic power for moving hydraulic cylinders 26, 32, 34, left and right travel motors 42L, 42R, and swing motor 43.

Operator station 20 may include devices that receive input from a machine operator indicative of desired machine maneuvering. Specifically, operator station 20 may include one or more operator interface devices 46, for example a joystick, a steering wheel, and/or a pedal, that are located proximate an operator seat (not shown). Operator interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

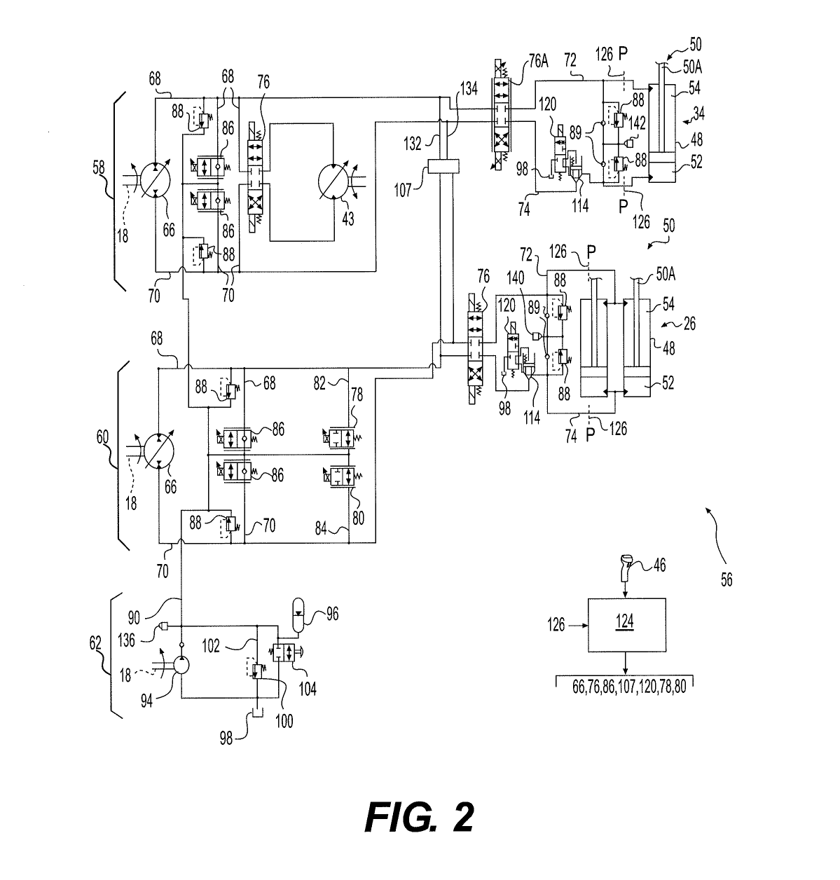

Two exemplary linear actuators (hydraulic cylinders 26 and 34) and one exemplary rotary actuator (swing motor 43) are shown in the schematic of FIG. 2. It should be noted that, while specific linear and rotary actuators are shown, the depicted actuators may represent any one or more of the linear actuators (e.g., hydraulic cylinders 26, 32, 34) or the rotary actuators (left travel, right travel, or swing motors 42L, 42R, 43) of machine 10.

As shown schematically in FIG. 2, hydraulic cylinders 26 and 34 may comprise any type of linear actuator known in the art. Each of hydraulic cylinder 26 and 34 may include a tube 48 and a piston assembly 50 arranged within tube 48 to form a first chamber 52 and an opposing second chamber 54. In one example, a rod portion 50A of piston assembly 50 may extend through an end of second chamber 54. As such, second chamber 54 may be considered the rod-end chamber of hydraulic cylinders 26 and 34, while first chamber 52 may be considered the head-end chamber.

First and second chambers 52, 54 may each be selectively provided with pressurized fluid and drained of the pressurized fluid to cause piston assembly 50 to move within tube 48, thereby changing an effective length of hydraulic cylinders 26 and 34 and moving work tool 14 (referring to FIG. 1). A flow rate of fluid into and out of first and second chambers 52, 54 may relate to a translational velocity of hydraulic cylinders 26 and 34, while a pressure differential between first and second chambers 52, 54 may relate to a force imparted by hydraulic cylinders 26 and 34 on the associated linkage structure of implement system 12. It should be noted that, although hydraulic cylinder 32 is not shown in FIG. 2, its structure and operation may be similar that described above with respect to hydraulic cylinders 26 and 34.

Swing motor 43, like hydraulic cylinders 26 and 34, may be driven by a fluid pressure differential. Specifically, swing motor 43 may include first and second chambers (not shown) located to either side of a pumping mechanism, such as an impeller, plunger, or series of pistons (not shown). When the first chamber is filled with pressurized fluid and the second chamber is drained of fluid, the pumping mechanism may be urged to move or rotate in a first direction. Conversely, when the first chamber is drained of fluid and the second chamber is filled with pressurized fluid, the pumping mechanism may be urged to move or rotate in an opposite direction. The flow rate of fluid into and out of the first and second chambers may determine an output velocity of swing motor 43, while a pressure differential across the pumping mechanism may determine an output torque. It is contemplated that a displacement of swing motor 43 may be variable, if desired, such that for a given flow rate and/or pressure of supplied fluid, a speed and/or torque output of swing motor 43 may be adjusted. It should be noted that, although travel motors 42L, 42R are not shown in FIG. 2, their structure and operation may be similar that described above with respect to swing motor 43.

As illustrated in FIG. 2, machine 10 may include a hydraulic system 56 having a plurality of fluid components that cooperate to move work tool 14 and machine 10. In particular, hydraulic system 56 may include, among other things, a first hydraulic circuit 58, a second hydraulic circuit 60, and a charge circuit 62. First hydraulic circuit 58 may be a bucket circuit associated with hydraulic cylinder 34 and swing motor 43, while second hydraulic circuit 60 may be a boom circuit associated with hydraulic cylinders 26. Charge circuit 62 may be selectively fluidly connected with each of first and second hydraulic circuits 58, 60 to receive excess fluid from the circuits or to provide makeup fluid to the circuits, as necessary. It is contemplated that additional and/or different configurations of circuits may be included within hydraulic system 56 such as, for example, a stick circuit (not shown) associated with hydraulic cylinder 32, left travel motor 42L, and right travel motor 42R, or an independent circuit associated with each separate actuator (e.g., with each of hydraulic cylinders 32, 34, 26, left travel motor 42L, right travel motor 42R, and/or swing motor 43), if desired. In addition, in exemplary embodiments, one or more of the circuits of hydraulic system 56 may be meterless circuits.

In the disclosed embodiment, each of first and second hydraulic circuits 58, 60 includes a plurality of interconnecting and cooperating fluid components that facilitate the simultaneous and independent use and control of the associated actuators. For example, each of first and second hydraulic circuits 58, 60 may include a pump 66 that is fluidly connected to its associated rotary and/or linear actuators in parallel via a closed-loop formed by first and second pump passages 68, 70. Specifically, pump 66 in first hydraulic circuit 58 may be connected directly to swing motor 43 via first and second pump passages 68, 70, and connected in parallel to hydraulic cylinder 34 via first and second pump passages 68, 70, a rod-end passage 72, and a head-end passage 74. Likewise, pump 66 in second hydraulic circuit 60 may be connected to hydraulic cylinders 26 via first and second pump passages 68, 70, a rod-end passage 72, and a head-end passage 74.

To cause swing motor 43 to rotate in a first direction, first pump passage 68 may be filled with fluid pressurized by pump 66, while second pump passage 70 may be filled with fluid exiting swing motor 43. To reverse direction of swing motor 43, second pump passage 70 may be filled with fluid pressurized by pump 66, while first pump passage 68 may be filled with fluid exiting swing motor 43. During an extending operation of a particular linear actuator (e.g., hydraulic cylinders 26 and/or 34), head-end passage 74 may be filled with fluid pressurized by pump 66, while rod-end passage 72 may be filled with fluid returning from the linear actuator. In contrast, during a retracting operation, rod-end passage 72 may be filled with fluid pressurized by pump 66, while head-end passage 74 may be filled with fluid returning from the linear actuator.

Each pump 66 may be a variable-displacement, over-center type pump. That is, pump 66 may be controlled to draw fluid from its associated actuator(s) and discharge the fluid at a specified elevated pressure through a range of flow rates back to the actuator(s) in two different directions. For this purpose, pump 66 may include a displacement controller, such as a swashplate and/or other like stroke-adjusting mechanism. The position of various components of the displacement controller may be electro-hydraulically and/or hydro-mechanically adjusted based on, among other things, a demand, a desired speed, a desired torque, and/or a load of one or more of the actuators to thereby change a displacement (e.g., a discharge rate) of pump 66. In exemplary embodiments, the displacement controller may change the displacement of pump 66 in response to a combined demand of one or more of left-travel motor 42L, right travel motor 42R, swing motor 43, and hydraulic cylinders 26, 32, 34. The displacement of pump 66 may be varied from a zero displacement position at which substantially no fluid is discharged from pump 66, to a maximum displacement position in a first direction at which fluid is discharged from pump 66 at a maximum rate into first pump passage 68. Likewise, the displacement of pump 66 may be varied from the zero displacement position to a maximum displacement position in a second direction at which fluid is discharged from pump 66 at a maximum rate into second pump passage 70. Pump 66 may be drivably connected to power source 18 of machine 10 by, for example, a countershaft, a belt, or in another suitable manner. Alternatively, pump 66 may be indirectly connected to power source 18 via a torque converter, a gear box, an electrical circuit, or in any other manner known in the art. It is contemplated that pumps 66 of different circuits may be connected to power source 18 in tandem (e.g., via the same shaft) or in parallel (via a gear train), as desired. It is also contemplated that any one or more of pumps 66 may alternatively be a non-overcenter (i.e., unidirectional) if desired.

Pump 66 may also be selectively operated as a motor. More specifically, when an associated actuator is operating in an overrunning condition, the fluid discharged from the actuator may have a pressure elevated higher than an output pressure of pump 66. In this situation, the elevated pressure of the actuator fluid directed back through pump 66 may function to drive pump 66 to rotate with or without assistance from power source 18. Under some circumstances, pump 66 may even be capable of imparting energy to power source 18, thereby improving an efficiency and/or capacity of power source 18.

During some operations, it may be desirable to cause movement of a linear actuator and/or a rotary actuator without causing movement of other actuators within the same circuit. It may also be desirable to selectively switch a flow direction of fluid passing through a linear and/or rotary actuator without switching the flow direction of fluid passing through other actuators within the same circuit and without switching a rotational direction of the pump. For these purposes, each of first and second circuits 58, 60 may be provided with a switching valve 76 capable of substantially isolating an associated rotary or linear actuator from its corresponding pump 66 and/or other hydraulic circuit components. Switching valves 76 may also be configured to selectively switch a flow direction of fluid passing through the associated rotary or linear actuator. In exemplary embodiments, switching valves 76 may be configured to independently switch the flow direction of each actuator within a particular circuit.

Switching valve 76 may be any type of non-variable, on/off type valve. Such valves may be, for example, two- or three-position, four-way spool valves that are solenoid-actuated between one or more flow-passing positions and are spring-biased toward a flow-blocking position. Such flow-passing positions may include, for example, a direct-flow position and a cross-flow position, wherein the cross-flow position may direct fluid in a direction opposite or reversed from the direct-flow position. When switching valves 76 are in one of the flow-passing positions, fluid may flow substantially unrestricted through first and second pump passages 68, 70 into and out of the rotary or linear actuators. When switching valves 76 are in the flow-blocking position, fluid flows within first and second pump passages 68, 70 may not pass into, out of, or through the rotary or linear actuators to substantially affect the motion of the rotary or linear actuator.

It is contemplated that switching valves 76 may also function as load-holding valves, hydraulically locking movement of the rotary and/or linear actuators. Such hydraulic locking may occur when, for example, the associated actuators have non-zero displacement and switching valves 76 are in their flow-blocking positions. Similar functionality may also be provided by dedicated shut-off valves 120 and load-holding valves 114 associated with the various linear actuators shown in FIG. 2. It is understood that, due to the construction of such valves, dedicated poppet-type load holding valves 114 and the like may have superior leakage and drift characteristics than, for example, spool-type switching valves 76.

It is contemplated that one or more of switching valves 76 may alternatively be a variable position valve, if desired. For example, in embodiments in which one or more of the rotary actuators are prevented from reaching zero displacement, the associated switching valve 76 may be a variable position valve. Such variable position switching valves 76 may be, for example, four-way spool valves and/or any other like valves or group of valves configured to have the flow-passing, flow-blocking, flow-restricting, flow-switching and/or other functionality described herein. In further exemplary embodiments, one or more of switching valves 76 may comprise four independent, two-position, two-way poppet valves.

Variable position switching valves 76 may be configured to controllably vary the amount of fluid passing therethrough, and an exemplary variable switching valve 76A is illustrated in FIG. 2 associated with first hydraulic circuit 58. Variable position switching valve 76A may permit passage of any desired flow rate of fluid. Such desired flow rates may vary between a substantially unrestricted flow at a fully open flow-passing position, and a completely restricted flow (i.e., no flow) at a fully closed flow-blocking position. In such exemplary embodiments, switching valves 76 may be configured to controllably vary, increase, decrease, and/or otherwise change a linear or rotational speed of the associated actuators, in addition to facilitating isolation and/or selective flow direction switching of the associated actuators. Such switching valves 76 may be configured to change the respective speeds of the associated actuators independently by restricting flow through the associated actuators.

For example, there may be times when one of pumps 66 provides fluid to more than one actuator simultaneously. In such applications, it may be desirable to change a speed of one of the actuators without changing a speed of the remaining actuators receiving fluid from pump 66, and a variable position switching valve 76 may be configured to independently change the speed of its associated actuator by variably restricting the flow of fluid through the actuator. Such flow and/or speed control may be useful when, for example, independently changing the rotational speed of swing motor 43 and/or hydraulic cylinder 34 when pump 66 of first hydraulic circuit 58 is providing fluid to each of these actuators simultaneously. It is understood that the flow of fluid through each of first and second hydraulic circuit 58, 60 may be controlled by the associated pump 66, and as this flow passes through respective switching valves 76, changing the conductance that switching valve 76 imposes on this flow may have the effect of altering the pressure difference across the switching valve 76. Thus, for a given flow passing through switching valve 76 to a respective actuator, such a change in conductance may dictate the speed of the actuator if the pressures balance the load being applied to the actuator. Although described above with respect to the exemplary actuators of first hydraulic circuit 58, variable position switching valves 76 may have similar functionality when associated with the actuators of any circuits of hydraulic system 56.

As also shown in FIG. 2, first and second hydraulic circuits 58, 60 may be fluidly connected to each other via a combining valve 107. Combining valve 107 may comprise one or more flow control components configured to facilitate directing fluid between first and second hydraulic circuits 58, 60 and/or combining fluid from two or more sources. In an exemplary embodiment, combining valve 107 may comprise a plurality of two- or three-position, variable (proportional-type) valve elements. In further exemplary embodiments, combining valve 107 may comprise a plurality of non-variable position on/off valve elements. In either configuration, the valve elements may be controlled to permit and/or restrict passage of fluid between first and second hydraulic circuits 58, 60. For example, combining valve 107 may be selectively fluidly connected to first pump passages 68 and/or second pump passages 70 of first and second hydraulic circuits 58, 60 via passages 132, 134. Through the various fluid connections of combining valve 107, fluid may be simultaneously provided from one or more pumps 66 to any of the actuators of hydraulic system 56. Combining valve 107 may also be configured to isolate one or more of first and second hydraulic circuits 58, 60 and/or components thereof.

For example, in some operations it may be desirable to supplement a flow of fluid provided to a particular actuator by pump 66 of first hydraulic circuit 58, with a flow of fluid from pump 66 of second hydraulic circuit 60 (or vice versa). For these purposes, combining valve 107 may be used to direct fluid from pumps 66 of either of first and second hydraulic circuit 58, 60 to the actuator simultaneously, thereby directing a “combined flow” of fluid to the actuator. With respect to, for example, first hydraulic circuit 58, such a combined flow of fluid may be required when hydraulic cylinder 34 is operated simultaneously with swing motors 43. In such operations, the combined demand of hydraulic cylinder 34 and swing motor 43 may exceed the maximum displacement of pump 66 of first hydraulic circuit 58. As a result, combining valve 107 may be controlled to combine fluid provided by pump 66 of second hydraulic circuit 60 with fluid provided by pump 66 of first hydraulic circuit 58, and to direct a combined flow of fluid to hydraulic cylinder 34 and swing motor 43. When such a combined flow of fluid from pumps 66 is directed to hydraulic cylinder 34 and swing motor 43 via combining valve 107, switching valve 76 associated with hydraulic cylinder 34 may be used to variably restrict flow through hydraulic cylinder 34 if combining valve 107 is not proportional. Alternatively, if combining valve 107 is proportional, combining valve 107 may be used to variably restrict flow through hydraulic cylinder 34, and switching valve 76 may be used simply as an on/off valve. In addition or in the alternative, switching valve 76 associated with swing motor 43 may be used to variably restrict flow through swing motor 43. Restricting flow with switching valves 76 while providing a combined flow to one or more of the actuators may assist in controlling the speed of the one or more actuators.

In further exemplary embodiments, combining valve 107 and switching valve 76 may be used to facilitate fluid regeneration of the associated linear actuators. For example, high-pressure fluid may be transferred from one chamber to the other of the linear actuator via switching valve 76 and combiner valve 107, without the fluid ever passing through pump 66. It is understood that when regenerating during extension of hydraulic cylinder 34, pump 66 of first hydraulic circuit 58 may supply fluid to hydraulic cylinder 34 in the amount of the difference between the flow into first chamber 52 and the flow exiting second chamber 54. Likewise, when regenerating during retraction of hydraulic cylinder 34, pump 66 of first hydraulic circuit 58 may receive excess fluid from hydraulic cylinder 34 in the amount of the difference between the flow into second chamber 54 and the flow exiting first chamber 52.

It will be appreciated by those of skill in the art that the respective rates of hydraulic fluid flow into and out of first and second chambers 52, 54 of hydraulic cylinders 26 and 34 during extension and retraction may not be equal. That is, because of the location of rod portion 50A within second chamber 54, piston assembly 50 may have a reduced pressure area within second chamber 54, as compared with a pressure area within first chamber 52. Accordingly, during retraction of hydraulic cylinders 26 and 34, more hydraulic fluid may be forced out of first chamber 52 than can be consumed by second chamber 54 and, during extension, more hydraulic fluid may be consumed by first chamber 52 than is forced out of second chamber 54. In order to accommodate the excess fluid discharge during retraction and the additional fluid required during extension, each of hydraulic cylinders 26 and 34 may be provided with two makeup valves 89 and two relief valves 88 that are fluidly coupled with a connection 136 of charge circuit 62 via respective connections 140 and 142. Relief and/or makeup valves 88, 89 may also or alternatively be used to protect passages of hydraulic circuit 58 from pressure shocks caused by loading of hydraulic cylinders 26 and 34 when switching valves 76 are closed. Each of first and second hydraulic circuit 58, 60 may include similar makeup valve 86 and relief valve 88 arrangements fluidly connected to charge circuit 62 via a common passage 90. It is to be understood that, to avoid damage to hydraulic cylinders 26 and 34 and/or to otherwise dissipate energy from the pressurized fluid leaving hydraulic cylinders 26 and 34, switching valve 76 associated with each cylinder 26, 34 may be configured to variably restrict flow through and/or otherwise reduce the speed of the respective cylinder 26, 34, even during regeneration.

Makeup valves 89 associated with hydraulic cylinders 26 and 34 may each be check valves or another type of valve configured to block flow in a first direction and to permit flow only in a second direction. For example, makeup valves 89 may be configured to selectively allow pressurized fluid from charge circuit 62 to enter rod-end passage 72 and/or head-end passage 74 via respective connections 140, 142. Such valves may, however, prohibit fluid from passing in the opposite direction.

Makeup valves 86 associated with first and second hydraulic circuits 58, 60, on the other hand, may each be variable position valves disposed between common passage 90 and one of first and second pump passages 68, 70, and each may be configured to selectively allow pressurized fluid from charge circuit 62 to enter first and second pump passages 68, 70. In particular, each of makeup valves 86 may be solenoid-actuated from a first position at which fluid freely flows between common passage 90 and the respective first and second pump passage 68, 70, toward a second position at which fluid from common passage 90 may flow only into first and second pump passage 68, 70 when a pressure of common passage 90 exceeds the pressure of first and second pump passages 68, 70 by a threshold amount. Makeup valves 86 may be spring-biased toward their second positions (i.e., makeup valves 86 may normally be in their second positions), and only moved toward their first positions during operations known to have need of positive (flow from charge circuit 62 into either first or second pump passages 68, 70) or negative (flow from either first or second pump passages 68, 70 into charge circuit 62) makeup fluid.

Makeup valves 86 may provide additional functionality. In particular, makeup valves 86 may also be used to facilitate fluid regeneration between first and second pump passages 68, 70 within a particular circuit, by simultaneously moving together at least partway to their first positions. In this situation, high-pressure fluid from one of first and second pump passages 68, 70 (i.e., fluid being discharged by the corresponding actuator) may be directed to the other of first and second pump passages 68, 70 for reuse within the same actuator (i.e., without the fluid ever passing through pump 66). In exemplary embodiments, makeup valves 86 may also assist in creating bypass flow for an “open center feel.” In particular, high pressure fluid from one of first and second pump passages 68, 70 (i.e., fluid being discharged by pump 66) may be directed to the other of first and second pump passages 68, 70, without the fluid ever passing through the corresponding actuator. This functionality may cause the associated actuator to stop when a load on the actuator increases during a constant motion command received from the operator via interface device 46. In such exemplary embodiments, flow from pump 66 may be diverted to charge circuit 62 via common passage 90 so as to reduce the energy imparted to and thereby the speed and/or force of the actuator. Such functionality may enable the operator to accomplish delicate position control tasks, such as cleaning a dirt wall with work tool 14 without breaking the dirt wall.

Relief valves 88 may be provided to allow fluid relief from hydraulic cylinders 26 and 34 and from each of first and second hydraulic circuits 58, 60 into charge circuit 62 when a pressure of the fluid exceeds a set threshold of relief valves 88. Relief valves 88 may be set to operate at relatively high pressure levels in order to prevent damage to hydraulic system 56, for example at levels that may be reached only when hydraulic cylinders 26 or 34 reach an end-of-stroke position and the flow from the associated pumps 66 is nonzero, or during a failure condition of hydraulic system 56.

Charge circuit 62 may include at least one hydraulic source fluidly connected to common passage 90 described above. In the disclosed embodiment, charge circuit 62 has two sources, including a charge pump 94 and an accumulator 96, which are fluidly connected to common passage 90 in parallel to provide makeup fluid to first and second hydraulic circuits 58, 60. Charge pump 94 may embody, for example, an engine-driven, fixed or variable displacement pump configured to draw fluid from a tank 98, pressurize the fluid, and discharge the fluid into common passage 90. Accumulator 96 may embody, for example, a compressed gas, membrane/spring, or bladder type of accumulator configured to accumulate pressurized fluid from and discharge pressurized fluid into common passage 90. Excess hydraulic fluid, either from charge pump 94 or from first and second hydraulic circuits 58, 60 (i.e., from operation of pumps 66 and/or the rotary and linear actuators) may be directed into either accumulator 96 or into tank 98 by way of a charge relief valve 100 disposed in a return passage 102. Charge relief valve 100 may be movable from a flow-blocking position toward a flow-passing position as a result of elevated fluid pressures within common passage 90 and return passage 102. A manual service valve 104 may be associated with accumulator 96 to facilitate draining of accumulator 96 to tank 98 during service of charge circuit 62.

One or more force modulation control valves 78, 80 may be associated with hydraulic system 56 to help regulate a speed and/or force of work tool 14 during particular situations. In the exemplary embodiment, only second hydraulic circuit 60 is provided with force modulation control valves 78, 80, these valves being coupled to regulate the force imparted by hydraulic cylinders 26 on work tool 14. It is contemplated, however, that force modulation control valves 78, 80 could alternatively or additionally be associated with hydraulic cylinder 34, swing motor 43, and/or other actuators (e.g., left and/or right travel motors 42L, 42R) and circuits of hydraulic system 56, if desired.

Force modulation control valves 78, 80 may be disposed within first and second bypass passages 82, 84, respectively, that connect first and second pump passages 68, 70 with common passage 90. Force modulation control valves 78, 80 may be arranged in parallel with makeup valves 86 and function in a somewhat similar manner. In particular, force modulation control valves 78, 80 may be solenoid operable to move to any position between a first or closed position and a second or fully open position (normal position—shown in FIG. 2). When force modulation control valves 78, 80 are in the first position, flow between first and second pump passages 68, 70 and common passage 90 via force modulation control valves 78, 80 may be inhibited. However, when force modulation control valves 78, 80 are in the second position, pressurized fluid from pump 66 may be allowed to bypass hydraulic cylinders 26 and flow from the higher pressure one of first and second pump passages 68 to the lower pressure one of first and second pump passages 68, 70 (and/or into common passage 90).

The amount of pressurized fluid from pump 66 that bypasses hydraulic cylinders 26 may be related to a reduction in speed and/or force of hydraulic cylinders 26. In particular, because there may be little resistance to the flow of fluid bypassing hydraulic cylinders 26 when force modulation control valves 78, 80 are fully in the second position, the pressure of the fluid within second hydraulic circuit 60 may remain low. This low-pressure fluid may result in a reduced speed and/or force capacity of hydraulic cylinders 26 and a corresponding increased controllability over the movement of work tool 14. As force modulation control valves 78, 80 are moved toward their flow-blocking positions, a greater resistance may be placed on the flow of bypassing fluid within second hydraulic circuit 60, thereby causing a corresponding rise in the pressure of all fluid within second hydraulic circuit 60 and in the resulting speed and/or force capacity of hydraulic cylinders 26. Accordingly, as an operator of machine 10 requests a greater force from hydraulic cylinders 26 (e.g., as the operator displaces interface device 46 by a greater distance), force modulation control valves 78, 80 may be caused to move toward their flow-blocking positions by a greater amount. When force modulation control valves 78, 80 are moved fully to the flow-blocking position, substantially no fluid may be bypassing hydraulic cylinders 26 via force modulation control valves 78, 80 such that full speed and/or force of hydraulic cylinders 26 may be available to the operator.

It should be noted that, when force modulation control valves 78, 80 are fully in the flow-blocking position, force modulation control valves 78, 80 may no longer be restricting the flow of any fluid through second hydraulic circuit 60. Accordingly, any metering losses associated with force modulation control valves 78, 80 may only be experienced when force modulation control valves 78, 80 are metering (i.e., in a position other than the first or second positions). As described above, the functionality provided by force modulation control valves 78, 80 may result in greater control over hydraulic cylinders 26 and allow hydraulic cylinders 26 to stop when a load on work tool 14 increases beyond a particular level, thereby enabling the operator to accomplish delicate position control tasks.

In the disclosed embodiment, force modulation control valves 78, 80 may provide for finer control over hydraulic cylinders 26, as compared with makeup valves 86. In particular, makeup valves 86 may be configured to pass a higher rate of fluid for a given command from the operator, while force modulation control valves 78, 80 may be configured to pass a lower rate of fluid. In one embodiment, the opening area and/or flow capacity of makeup valves 86 may be about twice as much as the opening area and/or flow capacity of force modulation control valves 78, 80 for a given operator input. This difference may allow makeup valves 86 to respond faster to makeup and/or regeneration demands of the corresponding system, and for force modulation control valves 78, 80 to provide for finer control over speed and/or force of hydraulic cylinders 26 for a given input from the operator. It is contemplated that, in some embodiments, force modulation control valves 78, 80 may be used together with makeup valves 86, if desired, to provide for simultaneous high speed makeup/regeneration and fine control of hydraulic cylinders 26.

During operation of machine 10, the operator of machine 10 may utilize interface device 46 to provide a signal that identifies a desired movement of the various linear and/or rotary actuators to a controller 124. Based upon one or more signals, including the signal from interface device 46 and, for example, signals from various pressure sensors 126 and/or position sensors (not shown) located throughout hydraulic system 56, controller 124 may command movement of the different valves and/or displacement changes of the different pumps and motors to advance a particular one or more of the linear and/or rotary actuators to a desired position in a desired manner (i.e., at a desired speed and/or with a desired force).

Controller 124 may embody a single microprocessor or multiple microprocessors that include components for controlling operations of hydraulic system 56 based on input from an operator of machine 10 and based on sensed or other known operational parameters. Numerous commercially available microprocessors can be configured to perform the functions of controller 124. It should be appreciated that controller 124 could readily be embodied in a general machine microprocessor capable of controlling numerous machine functions. Controller 124 may include a memory, a secondary storage device, a processor, and any other components for running an application. Various other circuits may be associated with controller 124 such as power supply circuitry, signal conditioning circuitry, solenoid driver circuitry, and other types of circuitry.

### INDUSTRIAL APPLICABILITY

The disclosed hydraulic system may be applicable to any machine where improved hydraulic efficiency and control is desired. The disclosed hydraulic system may provide for improved efficiency through the use of meterless technology, flow-sharing, and flow-combining. The disclosed hydraulic system may provide for improved control through the use of force modulation. Operation of hydraulic system 56 will now be described.

During operation of machine 10, an operator located within station 20 may tilt interface device 46 in a particular direction by a particular amount and/or with a particular speed to command motion of work tool 14 in a desired direction, at a desired velocity, and/or with a desired force. One or more corresponding signals generated by interface device 46 may be provided to controller 124 indicative of the desired motion, along with machine performance information, for example sensor data such a pressure data, position data, speed data, pump or motor displacement data, and other data known in the art.

For example, in response to the signals from interface device 46 indicative of a desire to lift work tool 14 with an increasing velocity, and based on the machine performance information, controller 124 may generate control signals directed to the stroke-adjusting mechanism of pump 66 within second hydraulic circuit 60, to switching valve 76, and/or to force modulation control valves 78, 80. These control signals may include a first control signal that causes pump 66 to increase its displacement and discharge pressurized fluid into first pump passage 68 at a greater rate, and a simultaneous second control signal that causes switching valve 76 to move into its direct-flow position (if not already in the direct-flow position). As described above, when switching valve 76 is in its direct-flow position, first pump passage 68 may be fluidly communicated with head-end passage 74, and rod-end passage 72 may be fluidly communicated with second pump passage 70. When fluid from pump 66 is directed into first chamber 52 via first pump and head-end passages 68, 74, return fluid from second chamber 54 of hydraulic cylinders 26 may flow back to pump 66 via rod-end and second pump passages 72, 70 in closed-loop manner.

At about this same time, a control signal may be sent to force modulation control valve 78 that is associated with first pump passage 68, causing force modulation control valve 78 to move to a position corresponding to the displacement of interface device 46. For example, if interface device 46 is displaced by only a small amount, force modulation control valve 78 may move to a relatively high-flow position, at which a large amount of fluid from first pump passage 68 may bypass hydraulic cylinders 26 and flow directly into second pump passage 70. In this situation, hydraulic cylinders 26 may be extending relatively slowly and/or with relatively little force. The extension may continue until work tool 14 becomes more heavily loaded or engages an immovable mass, at which time work tool 14 may stop moving and all of the fluid from first pump passage 68 may be forced to bypass hydraulic cylinders 26 and flow directly into second pump passage 68 via force modulation control valve 78.

If however, interface device 46 is displaced by a greater amount (e.g., moved further upon work tool movement stopping), force modulation control valve 78 may be caused by controller 124 to move to a more flow-restricting position, at which a lesser amount of fluid from first pump passage 68 may bypass hydraulic cylinders 26 and flow directly into second pump passage 70. In this situation, hydraulic cylinders 26 may extend more quickly and/or with greater force, as more fluid will be directed into hydraulic cylinders 26. As the operator continues to displace interface device 46 by greater amounts, force modulation control valve 78 will eventually close completely, and hydraulic cylinders 26 will move with a maximum force and/or at a maximum speed. In this manner, the operator may be provided with force control over hydraulic cylinders 26. Force modulation of other actuators within hydraulic system 56 may be regulated in a similar manner.

To drive hydraulic cylinders 26 at an increasing speed in a retracting direction (e.g., to lower work tool 14), controller 124 may generate a first control signal that causes pump 66 of second hydraulic circuit 60 to increase its displacement in a reverse flow direction and discharge pressurized fluid into second pump passage 70 at a greater rate, while simultaneously generating a second control signal that causes switching valve 76 to move into its direct-flow position (if not already in the direct-flow position). Alternatively, controller 124 could cause pump 66 to maintain the original flow direction and discharge fluid into first pump passage 68, while simultaneously causing switching valve 76 to move into its cross-flow position. Either strategy may result in pressurized fluid entering second chamber 54 of hydraulic cylinders 26 and exiting first chamber 52.

With regard to the first strategy described above, a control signal may be sent to force modulation control valve 80 that is associated with second pump passage 70, causing force modulation control valve 80 to move to a position corresponding to the displacement of interface device 46. When interface device 46 is displaced by only a small amount, force modulation control valve 78 may move to a relatively high-flow position and, when interface device 46 is displaced by a greater amount, force modulation control valve 78 may move to a more restricted position. The high-flow position may result in a relatively lower extending speed and/or force of hydraulic cylinders 26, as compared with the more restricted position. As described above, when fluid from pump 66 is directed into second chamber 54 of hydraulic cylinders 26, return fluid from first chamber 52 may flow back into pump 66 in closed-loop manner, thereby allowing hydraulic cylinder to retract at a speed and/or at a force related to the displacement of pump 66 and the position of force modulation control valve 70.

As described above, the rates of fluid flow into and out of hydraulic cylinders 26 (and hydraulic cylinders 32 and 34) may not be equal during normal extension and retraction operations. In order to accommodate the additional fluid required during extension, the excess output of pump 66 may be selectively directed into first hydraulic circuit 58 and/or charge circuit 62, or supplemental fluid may be directed from these other circuits into first hydraulic circuit 58.

For example, during extension of hydraulic cylinders 26, controller 124 may generate a control signal that causes pump 66 of first hydraulic circuit 58 to increase its displacement and discharge pressurized fluid at a greater rate, and a control signal that causes combiner valve 107 to pass additional flow from first hydraulic circuit 58 to combine with flow from second hydraulic circuit 60 entering first chamber 52. Alternatively, makeup fluid from charge circuit 62 may enter second hydraulic circuit 60 via makeup valves 86 and/or 88 to combine with flow entering first chamber 52.

In contrast, during retraction of hydraulic cylinders 26, controller 124 may generate a control signal that causes combiner valve 107 to pass excess flow from second hydraulic circuit 60 (i.e., some of the fluid exiting first chamber 52) into first hydraulic circuit 58. Alternatively, the excess fluid from first chamber 52 may be directed into charge circuit 62 via relief valves 88 and/or makeup valves 86.

In the disclosed hydraulic system, flows provided by the different pumps may be substantially unrestricted during modulation of the associated hydraulic actuators such that significant energy is not unnecessarily wasted in the actuation process. Thus, embodiments of the disclosure may provide improved energy usage and conservation. In addition, the closed-loop operation of hydraulic system 56 may, in some applications, allow for a reduction or even complete elimination of metering valves for controlling fluid flow associated with the linear and rotary actuators. This reduction may result in a less complicated and/or less expensive system.

The disclosed hydraulic system may also provide for force modulation of the different actuators. In particular through pressure control facilitated by force modulation control valves 78, 80, an operator of machine 10 may be provided with an additional and more controlled way in which the movement of work tool 14 may be manipulated. This control may provide for enhanced performance of machine 10.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system, comprising:
a pump configured to draw low-pressure fluid from one of a first passage and a second passage, and discharge fluid at an elevated pressure into the other of the first and second passages;
an actuator coupled to the pump via the first and second passages;
at least a first control valve fluidly connected between the first and second passages and configured to selectively direct fluid from one of the first and second passages to bypass the pump and flow into the other of the first and second passages; and
at least a second control valve fluidly connected in parallel with the at least a first control valve and configured to selectively direct fluid from one of the first and second passages to bypass the actuator and flow into the other of the first and second passages.

2. The hydraulic system of claim 1, wherein the at least a first control valve has a greater flow capacity than the at least a second control valve.

3. The hydraulic system of claim 2, wherein the flow capacity of the at least a first control valve is about twice as much as the flow capacity of the at least a second control valve.

4. The hydraulic system of claim 2, further including a makeup circuit, wherein the at least a first control valve is solenoid operable between a first position at which fluid is allowed to bypass the pump, and a second position at which fluid from the makeup circuit is allowed to flow into the first and second passages based on a pressure differential between the makeup circuit and the first and second passages.

5. The hydraulic system of claim 4, wherein when the at least a first control valve is in the first position, fluid bypassing the actuator may also be allowed to flow into the makeup circuit.

6. The hydraulic system of claim 5, wherein the at least a first control valve is normally in the second position.

7. The hydraulic system of claim 4, wherein the at least a first control valve includes:
a first control valve associated with the first passage; and
a second control valve associated with the second passage.

8. The hydraulic system of claim 7, wherein the at least a second control valve includes:
a third control valve associated with the first passage; and
a fourth control valve associated with the second passage.

9. The hydraulic system of claim 4, wherein the at least a second control valve is solenoid operable between a first position at which fluid is allowed to bypass the actuator, and a second position at which fluid flow through the at least a second control valve is blocked.

10. The hydraulic system of claim 9, wherein the at least a second control valve is normally in the first position.

11. The hydraulic system of claim 8, wherein the at least a first and at least a second are variable position valves configured to move to any position between the first and second positions.

12. The hydraulic system of claim 4, wherein the makeup circuit includes:
a charge pump; and
an accumulator fluidly connected to the charge pump and to the at least a first control valve.

13. The hydraulic system of claim 1, wherein the pump is an over-center variable displacement pump.

14. The hydraulic system of claim 1, further including a direction control valve fluidly connected to the first passage, the second passage, and the actuator, the directional control valve movable to control a direction of fluid flow through the actuator.

15. The hydraulic system of claim 14, wherein:
the pump is a first pump; and
the hydraulic system further includes:
a second pump; and
a combiner valve configured to selectively connect the first and second passages with the second pump.

16. The hydraulic system of claim 15, wherein:
the actuator is a first actuator;
the directional control valve is a first directional control valve; and
the hydraulic system further includes:
a second actuator; and
a second directional control valve fluidly coupled between the second pump and the combiner valve.

17. The hydraulic system of claim 16, wherein:
the second actuator is a linear actuator; and
the hydraulic system further includes:
a variable displacement rotary actuator fluidly connected to the second pump; and
a third directional control valve fluidly coupled between the second pump and the variable displacement rotary actuator.

18. The hydraulic system of claim 17, wherein:
the first, second, and third directional control valves are solenoid operated spool valves; and
the at least a first and at least as second control valves are solenoid operated poppet valves.

19. A hydraulic system, comprising:
a pump configured to draw low-pressure fluid from a first passage and discharge fluid at an elevated pressure into a second passage;
an actuator coupled to the pump via the first and second passages;
a directional control valve fluidly connected to the first passage, the second passage, and the actuator, the directional control valve movable to control a direction of fluid flow through the actuator;
a makeup circuit;
a first control valve disposed between the first passage and the makeup circuit;
a second control valve disposed between the second passage and the makeup circuit;
a third control valve disposed in parallel with the first control valve; and
a fourth control valve disposed in parallel with the second control valve,
wherein:
the first and second control valves are movable to any position between a normal position at which fluid from the makeup circuit is allowed to pass into the first and second passages based on a pressure differential across the first and second control valves, and an actuated position at which fluid from the first and second passages is allowed to bypass the pump;
the third and fourth control valves are movable to any position between a normal position at which fluid flow through the third and fourth control valves is blocked, and an actuated position at which fluid from the first and second passages is allowed to bypass the actuator;
the first and second control valves each have a flow capacity that is about twice a flow capacity of the third and fourth control valves; and
when the third and fourth control valves are in the actuated position, fluid bypassing the actuator may be allowed to flow into the makeup circuit.

20. A method of operating a hydraulic system, comprising:
drawing fluid from one of a first chamber and a second chamber of an actuator, pressurizing the fluid with a pump, and directing the pressurized fluid into the other of the first and second chambers of the actuator to move the actuator;
selectively directing a first flow of fluid from the actuator to bypass the pump and recuperate energy from the first flow of fluid; and
selectively directing a second flow of fluid from the pump to bypass the actuator in parallel with the first flow of fluid to selectively reduce a force of the actuator.

21. The method of claim 20, wherein the first flow of fluid has a greater flow rate than the second flow of fluid.

22. The method of claim 21, wherein the first flow of fluid has a flow rate that is a about twice as much as the flow rate of the second flow of fluid.

23. The method of claim 20, further including directing the first and second flows of fluid into a makeup circuit.

24. The method of claim 23, further including reversing the first flow of fluid to pass fluid from the makeup circuit to the pump.

25. The method of claim 20, further including reversing a direction of the pump to reverse a movement direction of the actuator.

26. The method of claim 25, wherein:
the actuator is a first actuator; and
the method further includes:
directing the pressurized fluid from the pump to a second actuator; and
moving a directional control valve associated with the first actuator to reverse the movement direction of the first actuator.

27. The method of claim 26, wherein:
the pump is a first pump; and
the method further includes directing pressurized fluid from a second pump to the actuator.
